(19) United States
(12) Patent Application Publication
(10) Pub. No.: US 2010/0250397 A1
(43) Pub. Date: Sep. 30, 2010

(54) Internet Retail Sales Method and System Using Third Party Web Sites

(76) Inventor: Gregory Ippolito, Manhattan Beach, CA (US)

Correspondence Address: Cislo & Thomas LLP, 1333 2nd Street, Suite #500, Santa Monica, CA, 90401-4110, US

(21) Appl. No.: 12/410,371

(22) Filed: Mar. 24, 2009

(51) Int. Cl. G06Q 30/00; G06F 15/16

(52) U.S. Cl. 705/27; 705/26; 709/203; 715/234; 705/14.23

(57) ABSTRACT

System, computer readable medium, and computer implemented method for displaying products from vendors for immediate sale on webpages generated by a web publisher server, the web publisher providing no infrastructure for such purchase. The vendor's product, product description, and purchase link on the webpage generated by the web publisher bypasses the traditional link traversal to the vendor's home page. In one embodiment, a set of scripts are embedded within the standard markup language of a webpage. When executed, the scripts cause the browser to request product information from the product server when the client computer parses and renders the webpage. The product information includes a uniform resource locator to directly purchase the advertised product from the product server. A “Buy Now” link corresponding to the uniform resource locator is “clicked” on by the user from the webpage to purchase the product.

### FIELD OF THE APPLICATION

The present application relates to the internet and more particularly, to an internet retail sales system and method for allowing a user to purchase products immediately from a third party website on a webpage generated by a web content publishers, the web content publishers providing no financial infrastructure for the purchase.

### BACKGROUND

The internet is a global system of interconnected computer networks that interchange data by packet switching using standardized Transmission Control Protocol/Internet Protocol (TCP/IP). The computer networks are linked by copper wires, fiber-optic cables, wireless connections, and other technologies. Accessible via the internet is the World Wide Web, which is a system of interlinked hypertext documents. With a web browser, users may view webpages through the World Wide Web.

Webpages consist of markup language, such as HTML, along with associated files for graphics and scripts. Hypertext links are also provided on webpages. These links allow a user to navigate to webpages pointed to by the link.

Certain links within the webpages provide advertisements which deliver marketing messages to attract customers. By “clicking” on an advertisement, the visitor is directed to a third party website of the advertiser. From there, the visitor navigates through the third party website to find the advertised product before making a purchase.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one aspect of the present application, a system is provided. The system includes a server connected to a network for receiving product requests from user agents via the network. The server includes at least one processor, a database for storing product information, and a memory operatively coupled to the processor. The memory stores program instructions that when executed by the processor, causes the processor to receive a product request from a user agent via the network, determine product information about at least one product from the database based on the product request, the product information including a uniform resource locator to immediately purchase the at least one product, and send the product information to the user agent via the network.

In accordance with another aspect of the present application, a computer readable medium storing instructions for causing at least one processor to perform a method that allows a user to purchase products immediately from a product server using pages generated by a host server while freeing the host server from having to possess any financial transaction infrastructure is presented. The method includes generating a page request to the host server and receiving a page based on the page request from the host server, the page having scripts embedded therein. The method also includes executing the scripts on the page, wherein the scripts, when executed by the processor, request product information from the product server. The product information includes locators for immediate purchase of a product through the product server. In addition, the method includes receiving product information from the product server and displaying the product information from the product server.

In accordance with yet another aspect of the present application, a computer-implemented method for providing a page displaying at least one product for immediate purchase without providing infrastructure for such purchase is provided. The method includes receiving a page request from a user agent. In addition, the method includes generating a page based on the page request. The page includes at least one script for execution by the user agent, wherein execution of the script by the user agent causes the user agent to request products from a product server for immediate purchase. The method also includes sending the page to the user agent.

In accordance with still yet another aspect of the present application, a system is presented. The system includes a host server receiving a page request, wherein the host server generates a page in response to the page request. The page incorporates at least one script. The system also includes a client computer receiving the page from the host server, wherein the client computer executes the at least one script within the page. The script generates a request for product information. In addition, the system includes at least one product server for receiving the request for product information from the client computer, wherein the product server determines product information about at least one product including a uniform resource locator to directly purchase the at least one product from the product server. The product server responds to the request for product information by sending the product information about the at least one product to the client computer.

In accordance with another aspect of the present application, a method for purchasing products directly from a third party website using a webpage generated by a host server and displayed by a browser supported on a graphical user interface is presented. The method includes sending an HTTP request to the host server, wherein the host server generates a webpage in response to the HTTP request. The webpage incorporates standard markup language and JavaScript embedded within the standard markup language. The method includes executing the JavaScript embedded within the standard markup language, wherein execution of the JavaScript causes a request for product information from the third party website. The third party website generates product information corresponding to the request for product information. The product information includes a URL for immediately purchasing a product. The product information is formulated into standard markup language.

The method also includes receiving the product information formulated into standard markup language from the third party website. The product information is returned to the JavaScript which caused the request for product information. In addition, the method includes displaying the standard markup language from the host server and the product information formulated into standard markup language including the URL for immediately purchasing the product to the user through the browser supported on the GUI.

In accordance with another aspect of the present application, an internet retail sales system for reducing steps required to purchase an advertised product by a user is presented. The system includes a host server for receiving a page request wherein the host server generates a page in response to the page request. The page incorporates at least one script for displaying the advertised product. The system also includes a client computer receiving the page from the host server, wherein the client computer executes the at least one script within the page. The script generates a request for product information about the advertised product.

The internet retail sales system also includes a product server for receiving the request for product information about the advertised product from the client computer, wherein the product server determines product information about the advertised product including a uniform resource locator to directly purchase the advertised product from the product server. The product server responds to the request for product information by sending the product information about the advertised product to the client computer.

In addition, the client computer receives from the user a purchase intent for the advertised product and sending the purchase intent to the product server. The advertised product is purchased directly by the user through the uniform resource locator.

In accordance with another aspect of the present application, a computer-implemented method for providing a page displaying at least one product for immediate purchase without providing infrastructure for such purchase is presented. The method includes receiving a page request from a user agent and generating a page based on the page request. In addition, the method includes requesting product information from a third party website, the third party website generating the product information corresponding to the product information request, the product information including a URL for immediately purchasing a product and formatted into standard markup language. Furthermore, the method includes receiving the product information formatted into standard markup language from the third party website. The method also includes merging the product information formatted into standard markup language from the third party website with the page based on the page request and serving the page to the user agent.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a block diagram that shows an exemplary computer architecture used for operating software such as a web browser in accordance with one aspect of the present application;

FIG. 2 is a diagram illustrating an exemplary environment for the system in accordance with one aspect of the present application;

FIG. 3 shows an exemplary browser supporting a webpage having the “Buy Now” feature in accordance with one aspect of the present application;

FIG. 4A depicts illustrative routines for providing an advertisement from a third party website on a webpage generated by a host server in accordance with one aspect of the present application;

FIG. 4B depicts illustrative routines for providing a purchase intent through the advertisement generated by a third party website on a webpage generated by a host server in accordance with one aspect of the present application;

FIG. 5A is an exemplary flow chart showing illustrative processes used by a client computer to purchase a product through a third party website using a webpage generated by a host server in accordance with one aspect of the present application;

FIG. 5B is an exemplary flow chart showing illustrative processes used by a host server to generate a webpage so that products can be purchased through a third party website in accordance with one aspect of the present application; and

FIG. 5C is an exemplary flow chart showing illustrative processes used by a product server to generate advertisements so that the advertisements can be displayed on the webpage generated by the host server and directly purchased immediately from the product server in accordance with one aspect of the present application.

### DETAILED DESCRIPTION

The detailed description set forth below in connection with the appended drawings is intended as a description of presently-preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

Generally described, the present application relates to a system and method for internet sales. More specifically, the present application relates to a system and method for displaying products from third party vendors for immediate sale on webpages generated by publishers, the publisher providing no infrastructure for such purchase. The vendor's product, product description, and purchase link on the webpage bypasses the traditional link traversal to the vendor's home page whereby the visitor spends time navigating through the website hierarchy to find the relevant product.

In one illustrative embodiment, the internet retail sales system reduces the steps required to purchase a product for sale through a client computer, webpage publisher, and vendor. Initially, the client computer sends a webpage request to the webpage publisher. In turn, the webpage publisher receives the webpage request and generates a webpage in response to the request. The webpage incorporates at least one script for product information. The client computer receives the webpage and executes the at least one script with the webpage. When executed, the script generates a request for product information regarding a product for sale from the vendor. The vendor receives the request for product information from the client computer. The vendor then determines product information for a product for sale including a uniform resource locator (URL) to immediately and directly purchase the product for sale from the vendor. The vendor sends the product information about the product for sale to the client computer, the client computer displaying the information to the user.

In another illustrative embodiment, the host server provides a webpage having standard markup language from a webpage publisher and vendor removing the need for any client script execution. Initially, and similar to the previous embodiment, client computer sends a webpage request to the webpage publisher. In turn, the webpage publisher receives the webpage request and generates a webpage in response to the request. A request is made to the vendor from the webpage publisher. The vendor receives the request for product information from the webpage publisher. The vendor then determines product information for a product for sale including a uniform resource locator (URL) to immediately and directly purchase the product for sale from the vendor. The vendor sends the product information about the product for sale to the webpage publisher formatted into standard markup language. The webpage publisher merges the product information formatted into standard markup language from the vendor with the page based on the page request and serves the page to the client computer.

Associated with the URL for immediately and directly purchasing the product for sale, is a hyperlink with anchor text that allows a user of the client computer to buy the product immediately. After a user selects the hyperlink, the client computer sends a purchase intent to the vendor. The product for sale is thereby purchased directly from the vendor without going through the webpage publisher who generated the webpage. Alternatively, the hyperlink links to a page that allows the user to enter their name, credit card information, etc. to make a purchase. The hyperlink would direct the user to a webpage generated by the vendor and not the webpage publisher freeing the publisher from the financial infrastructure thereby eliminating the complexity of complying with PCI-DDS security standards as set forth at http://www.picsecuritystandards.org and other regularity financial safeguards.

Displaying products from third party vendors for immediate sale on a webpage generated by a webpage publisher eliminates the need for searching through a vendor's website. This allows for quicker sales of the product as visitors on the webpage will not be intimidated by spending time searching for the product. Also, this improves product exposure. Directly linking the vendor frees up the webpage publisher from providing any financial infrastructure on the generated webpage.

Before describing further details of the system and method presented in this application, the term vendor incorporates the terms ad broker, ad aggregator, and as used primarily in this application, product server. In addition, the terms webpage publisher includes host server, the name generally used throughout this application.

Furthermore, while this application primarily relates to products, one skilled in the relevant art will appreciate that this application goes beyond the sale of products through the internet. As such, services, funds, goods, and data can also be sold or exchanged through the system and method presented in this application.

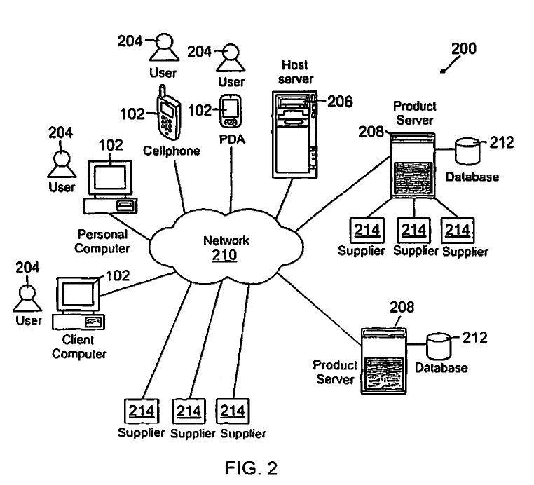

FIG. 2 is a diagram illustrating an exemplary environment for a system 200 in which products and services may be purchased directly from product server 208 by user agent 102 viewed from a webpage generated by host server 206 in accordance with one aspect of the present application. User agent 102, coupled to network 210, may take the form of a cell phone, personal digital assistant (PDA), lap top computer, stationary personal computer, IPTV remote control, web tablet, laptop computer, pocket PC, a television set capable of receiving IP based video services and mobile IP device, etc. User agent 102, in this application, can also be referred to as a browser.

Other exemplary components include host server (or webpage publisher) 206 and product servers (or vendors) 208, each coupled to network 210. Network 210 can respond to document requests and/or other queries from user agent 102, host server 206, and product server 208.

Network 210 is a group of two or more computer systems linked together. Network 210 typically transfers data from one source to another. To communicate efficiently, user agent 102, host server 206, and product server 208 connected via network 210 use a common set of rules and signals, also known as a protocol. The protocol determines the type of error checking to be used; what data compression method, if any, will be used; how the sending device will indicate that it has finished sending a message; and how the receiving device will indicate that it has received a message. Programmers may choose from a variety of standard protocols. Existing electronic commerce systems typically use Internet Protocol (IP) usually combined with a higher-level protocol called Transmission Control Protocol (TCP), which establishes a virtual connection between a destination and a source. IP is analogous to a postal system in that it allows the addressing of a package and dropping it in the system without a direct link between the sender and the recipient. TCP/IP, on the other hand, establishes a connection between two hosts so that they can send messages back and forth for a period of time.

Simple object access protocol (SOAP) is a simple, XML-based protocol for exchanging structured and type information on the web between user agent 102, host server 206, and product server 208. Particularly useful for this system 200 is that SOAP has no application or transport semantics, which makes it highly modular and extensible.

SOAP forms the foundational layer of the web services protocol stack providing a basic messaging framework upon which abstract layers can be built. SOAP procedures can be used to correctly format a call for data. The website receiving the call for data would then return a formatted XML document with all the required results and associated data. The data could be integrated directly into a third party website.

While SOAP is used in one embodiment, numerous other types of protocols exist. Asynchronous JavaScript and XML (AJAX) is a group of interrelated web development techniques used for creating interactive web applications or rich internet applications. With AJAX, web applications can retrieve data from the server asynchronously in the background without interfering with the display and behavior of the existing page. Data is retrieved using the XHMLHttpRequest object or through the use of remote scripting in browsers that do not support it.

Computer networks 210 can be classified as falling into one of two broad architectures; peer-to-peer or client/server architecture. Most networks 210 used for internet sales are classified as being a client/server architecture.

Host server 206 and product server 208 are computers or devices on network 210 that manage data. Typically, users 204 on network 210 can store or retrieve files from host server 206 and product server 208. While not shown, numerous other types of servers exist including a database server for storing and managing information, print server that manages one or more printers, and a network server that manages network 210 traffic.

Host server 206 and product server 208 are often dedicated, meaning that they perform no other tasks besides their server tasks. On multiprocessing operating systems, however, a single computer can execute several programs at once. A server in this case could refer to the program that is managing resources rather than the entire computer.

Internet retail as used in this specification refers to all aspects of business and market processes enabled by the Internet and World Wide Web technologies. Internet retail can be between two businesses transmitting finds, goods, services and/or data, between a business and a customer, between two consumers or any possible combination of the aforementioned entities. Typically the internet retail system 200 illustrated in FIG. 2 includes a network 210 and a plurality of user agents 102. In addition, the internet retail system 200 incorporates a host server 206 and at least one product server 208, each having access to network 210.

Host server 206 and product server 208, coupled to network 210, primarily provide services to user agent 102 that connects from remote locations. Typically, host server 206 and product server 208 run on multi-user operating systems such as UNIX, MVS or VMS, or at least an operating system with network services such as Windows NT, NetWard NDS, or NetWire Bindery.

Host server 206 and product server 208 can also optimize their performances. In typical embodiments, host server 206 and product server 208 maintain a time out function. Time outs are issued when remote systems, such as a user agent 102, fail to respond within a reasonable time during an exchange of data over a connection. Such time varies, but typically the time out occurs after a few minutes. User agent 102 may also time out, when no response is heard from host server 206 or product server 208.

Generally, time outs occur when either the user agent 102, the host server 206, the product server 208, or any part of the system 200 crashes or become disconnected from the network 210.

While more details are provided below, host server 206, as provided in internet retail system 200, generates webpages incorporating markup language such as HTML with scripts to be executed by a requesting user agent 102. Typically, host server 206 is a server that has access to other computers on the network 210. The host server 206 may provide services, such as news, mail, or data to user agent 102 that are remotely located from host server 206.

Product server 208 processes requests for product information and purchase intents from network 210. Product server 208 can be a website. The website contains standard markup language documents and associated files, scripts, and databases 212 that are served by a hypertext transfer protocol (HTTP) server on the World Wide Web. Preferably, however, a SOAP server is used and does not run a web server. If product server 208 is an AJAX server, a web server can be run using an HTTP protocol that may or may not have a home page.

Product server 208 may also be coupled to database 212, which maintains a set of records or information about products. Product information generally includes, but is not limited to, products for sale, product codes, and keyword tags. While product codes specify products for display, keyword tags are used for database 212 queries to provide the information for display.

The product server 208 may connect to, and query multiple vendor databases in addition to its' own to supply product data results which would typically include a product image, product description and URL to immediately and directly purchase the product for sale from the vendor. The product server 208 will typically return a single response to the JavaScript which made the request or in the second embodiment of this patent, the product server 208 will provide a single response to the host server 206 which aggregates the ad content with the web page.

Furthermore, database 212 maintains product information that is used by user agent 102 for display. The information can include, but is not limited to, a URL to an image of the product a product description, a URL for more product information, a uniform resource locator for more information on the vendor, and a URL to immediately purchase the product. Product information may be organized and maintained in fields in database 212. The product server 206 along with database 212 typically provide a set of operations for searching, sorting, recombining, and other functions related to the product information.

When product information is sent back to the requesting party, preferably, the information is formatted into standard markup language (or a variant web display technology). User agent 102 receives the standard markup language and URL and thereafter renders the page. The data delivered by product server 206 includes information and a URL to form a link to product server 206 which can perform the financial transaction, i.e. through entering credit card transaction, name, address, and contact information of the user 204. At this point a purchase intent can be generated by user 204 using user agent 102.

In some embodiments, the product described by the product information sent back to the requesting party is marked as pending within database 212 to prevent other parties from purchasing the product. Alternatively, the product is not marked as pending when the product may be made and shipped out quickly or there are lots of products described by the sent product information.

Database 212 can be controlled by a database administrator. The administrator can determine the content, internal structure, and access strategy for the database 212. In addition, the administrator defines security and integrity, and monitors performance. A database management system may also be provided, which provides a software interface between the database 212 and the network 210. The database management system handles user 206 requests for database actions and allows for control of security and data integrity requirements.

Coupled to the product server 208 is a plurality of suppliers 214. While not limited to suppliers 214, the product server 208 can be connected to any party who provides goods or services to a company. Suppliers 214 of the products often manufacturer items and sell those items to a customer, which in this system 200, means over the network 210 to a user 204 through user agent 102. The administrator may determine which products from the suppliers 214 may be placed into the database 212 and thereby ready for sale by the product server 208. Suppliers 214 can be either directly connected to product server 208 or more preferably, through network 210 as shown in FIG. 2.

In typical embodiments, the product server 208 can be an advertising aggregator. An ad aggregator is a company that connects websites that want to host advertisements with advertisers who want to run advertisements. The ad aggregators often pay money to websites that allow their ads to be shown when people use their software or visit their sites. Generally, payment is by cost-per-impression (CPM) and cost-per click (CPC). Payment, as provided through this system, would include CPM, CPC, and percentages of sales from affiliates like Amazon. Such ad aggregators may include AdWords, Burst Media, and Tribal Fusion. Product server 208 may also go by ad broker or vendor.

Preferably, the source of an ad request is from the JavaScript that gets executed in the web browser. The JavaScript makes a request to a processor running on product server 208, which performs the database 212 request and returns a result to the JavaScript program running in the browser on user agent 102. While SOAP is preferred, it is not limiting to other protocols used for retrieving information from database 212.

In another embodiment, host server 206 runs processes which make product requests to product server 208 and merges results from product server 208 into a webpage generated by host server 206. Host server 206 merges the information from product server 208 with a webpage generated by host server 206 before the webpage is served to user agent 102. In this embodiment, no JavaScript is executed by user agent 102 and the webpage served to user agent 102 can include links for directly purchasing products provided by product server 208.

For purposes of illustration, the system 200 shown in FIG. 2 includes a plurality of user agents 102, a single host server 206, and a plurality of product servers 208. The plurality of product servers 208 each has a single database 212 and multiple suppliers 214. Alternatively, system 200 may include multiple host servers 206 along with single suppliers 214 for each product server 208. As illustrated, system 200 may incorporate additional or fewer components and FIG. 2 should not be construed as limiting to the present scope of this application.

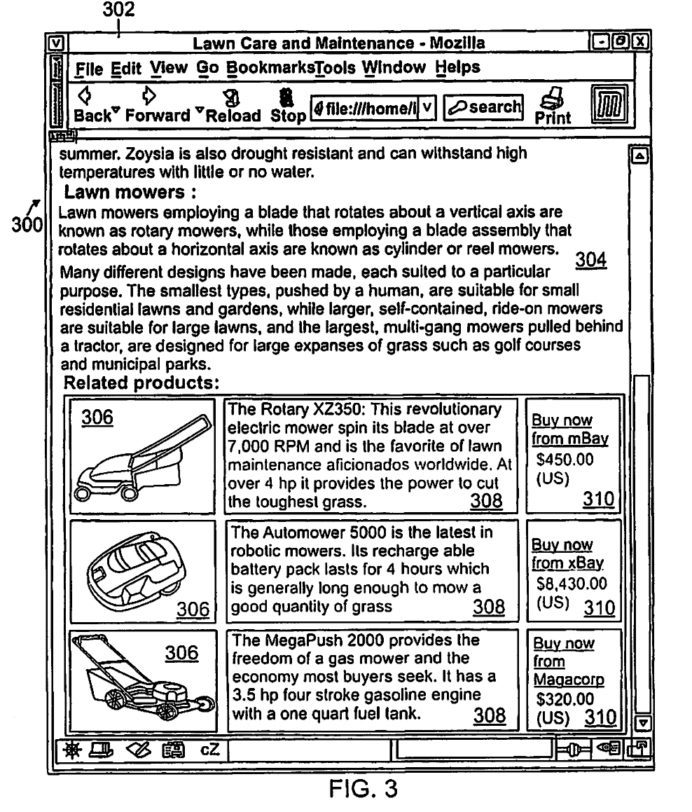

User agent 102 can also be referred to as a browser 302, which parses and renders standard markup language while executing JavaScript defined in webpages generated or served by host servers 206. Browser 302 is a software application that runs on user agents 102 and enables a user 204 to display and interact with text, images, videos, music, games, and other information typically located on a webpage 300 at a website on the World Wide Web or a local area network as depicted in FIG. 3.

When rendered by browser 302, webpage 300 contains text 304 generated by host server 206, which discusses relevant topics that user 204 requested from host server 206. In this illustration, user 204 requested information regarding lawnmowers from host server 206. Hyperlinks may also be included within the webpage 300. These hyperlinks may direct the user 204 to other webpages 300 within the same website or a different website. As such, browser 302 allows a user 204 to quickly and easily access information provided on many webpages 300 at many websites by traversing these links.

Browser 302 displaying webpage 300 also incorporates product information from the product server 208. Typically, this information is formatted into an advertisement with the option to click through to the vendor's website. Illustrated on the bottom portion of webpage 300, text 308 and images 306 corresponding to products for sale are provided. In other embodiments, either text 308 or images 308 may be displayed. In addition, product codes, keyword tags, and vendor information may also be displayed. When keywords tags have been matched with keywords by product server 208, in one embodiment, those keywords may be highlighted within the displayed text 308.

Webpage 300 also provides hyperlinks 308 corresponding to each displayed product. As shown below, hyperlinks 308 directly link user agent 102 to product server 208, which allows the host server 206 that generated webpage 300 to be free from any financial infrastructure regarding the purchase of the product.

Continuing with FIG. 3, the information generated by host server 206 may be displayed in a first portion of webpage 300 and the requested product information in a second portion of webpage 300. Alternatively, the product information can be displayed in the form of a banner advertisement, pop-up screen, or complete separate screen. Furthermore, each webpage 300 generated by host server 206 can display one or multiple products for sale.

Browser 302 typically formats standard markup language information, such as HTML, for display, so the appearance of a webpage 300 may differ between browsers 302. Some examples of browsers 302 include Internet Explorer, Mozilla Firefox, Safari, Netscape, Opera, Avant Browser, Konqueror, Google Chrome, Flock, Arachne, Epiphany, K-Meleon, and AOL Explorer.

Although browser 302 is generally used to access the World Wide Web, browser 302 can also be used to access information provided by servers in private networks or content in file systems. Browser 302 typically communicates with host server 206 and product server 208 using HTTP to fetch webpages 300. HTTP allows browser 302 to submit information to servers 206 and 208 as well as fetch webpages from them. While an HTTP request will be made to host server 206, the request to server 208 may be HTTP, SOAP, AJAX, etc. The most commonly used HTTP is HTTP/1.1, which is fully defined in RFC 2616.

Webpages 300 are located by means of a uniform resource locator, which is treated as an address, beginning with http: for HTTP access. Many browsers 302 also support a variety of other URL types and their corresponding protocols, such as gopher: for Gopher (a hierarchical hyper-linking protocol), ftp: for FTP (file transfer protocol), rtsp: for RTSP (real-time streaming protocol), and https: for HTTPS (an SSL encrypted version of HTTP).

To access webpage 300, user 204 from user agent 102 requests webpage 300 from host server 206 through network 210. Host server 206, in preferred embodiments, is uniquely identified by a host server name which is also known as a DNS or domain name. For example, to request a webpage 300 from a host server 206 on network 210, the user 204 of user agent 102 enters a URL on the input device 142. The user agent 102 supplies the requested URL to network adapter 152. The network adapter 152 transmits the request for webpage 300 from user agent 102 to the DNS for the IP address of the node in the domain. The DNS returns the IP address of the node in the domain (web server) to the user agent 102. User agent 102 using the IP address of the node in the domain then requests from host server 206 a webpage 300. In response to the request, host server 206 supplies the requested webpage 300 to the appropriate user agent 102.

File formats for webpage 300 are usually in a standard markup language such as HTML or XML and are identified in the HTTP protocol using a multipurpose internet mail extensions (MIME) content type. Product server 208 is generally not limited to an HTTP protocol and preferably uses SOAP web services protocol. Most browsers 302 generally support a variety of formats in addition to HTML, such as JPEG, PNG, and GIF image formats, and can be extended to support more through the use of plug-ins. The combination of HTTP content type and URL protocol allows webpage 300 designers to embed images 306, animations, video, sound, and streaming media into webpage 300, or to make them accessible through webpage 300.

Embedded within the markup language are a set of scripts for client-side web development. The scripts can run locally on user agent 102 through browser 302, rather than a remote server. The scripts will generate requests to the product server 208. After receiving a response from the product server in the form of product information, the browser 302 will place that information into webpage 300.

One scripting language, JavaScript, may be used and embedded within the markup language. JavaScript is useful as it is not compiled and is thus portable between platforms. Furthermore, basic online applications and functions can be added to webpages 300 with JavaScript. JavaScript accesses objects embedded in other applications. Typically, the JavaScript interacts with the Document Object Model (DOM) of webpage 300.

JavaScript code runs locally on user agent 102 making it more responsive to user 204. JavaScript code can also detect user actions when markup language cannot, such as individual keystrokes from input device 142.

Associated with JavaScript code is a JavaScript engine or JavaScript interpreter on user agent 102. The engine interprets the JavaScript source code and executes the script accordingly. The web browser 302 typically uses the public application protocol interface (API) to create “host objects” responsible for reflecting the DOM into JavaScript.

When webpage 300 is loaded into browser 302, including the standard markup language and scripts, monitor 146 displays the general content provided by host server 206 along with the product information provided by product server 208. Preferably, the display of the product information on the monitor 146 does not interfere with the display of the requested webpage 300.

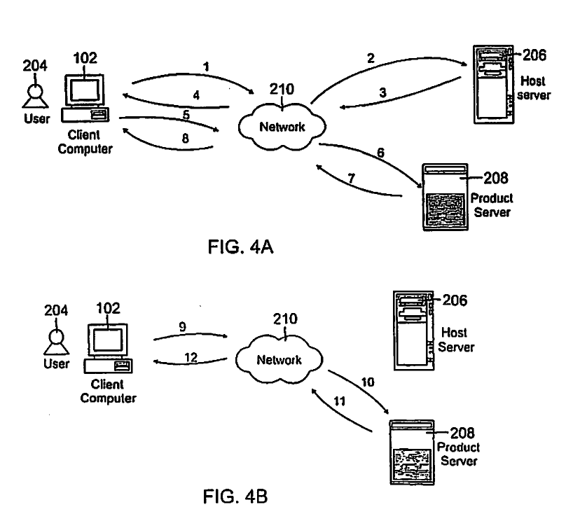

With reference now to FIG. 4A, illustrative processes for displaying products for immediate sale from a third party product server 208 on webpage 300 generated by host server 206 is presented, host server 206 providing no financial infrastructure for the display or purchase of the product. Initially, user agent 102 generates a request for webpage 300 from host server 206 through network 210. The host server 206 is generally identified by a unique host server name also known as a DNS or domain name. For example to request the general webpage from the Lawn Mower host server 206 on network 210, user 204 enters the following URL, http://www.lawnmower.com or other website, on the input device 142. User agent 102 supplies the requested URL to the network adapter 152 and to network 210.

When the user 204 makes a request through the URL, browser 302 opens a connection to host server 206 and initiates a request through a URL (e.g., an HTTP get) for the document. The domain reference in the URL is used to make a request to the DNS by the browser for the IP address of the node in the domain. The DNS returns the IP address of the node in the domain (web server) to the user agent 102. User agent 102 using the IP address of the node in the domain then requests from host server 206 a webpage 300.

In response to the request, host server 206 delivers the requested document, typically in the form of a text document coded in a standard markup language such as HTML. Embedded within the markup language is at least one script, preferably written in JavaScript. The host server 206 fulfills the webpage 300 request to the web browser 302 by sending the webpage 300 back to user agent 102 through network 210.

When user agent 102 receives webpage 300, browser 302 begins to parse and render the markup language and execute any scripts within page 300. When the scripts are executed, browser 302 running on user agent 102 makes a request to product server 208, the process running on product server 208 receiving the request will process this request to determine whether there are products for sale by product server 208.

Along with the request for products, the request by user agent 102 preferably includes keywords or product codes. Product codes specify products that are to be displayed on webpage 300 by browser 302. Keywords are used for database 212 queries, the database 212 matching the keywords with keyword tags located within database 212. Once matched, the product associated with the keyword tags would be displayed on webpage 300 by browser 302.

Keywords or products codes are generally determined by host server 206 when webpage 300 is generated. Keywords or product codes can be generated by user agent 102 where the previous pages visited in the website stores keywords in cookies representing topics or products of interest. Keywords and product codes can be automatically generated by searching through previous webpages 300 visited by the user or cookies stored on user agent 102 where the previous pages visited in the website store keywords in cookies representing topics or products of interest. Furthermore, instead of the host server 206 generating keywords or product codes from text 304, user agent 102 can generate them.

In other embodiments, the request by browser 302 does not include keywords or product codes thereby allowing product server 208 to generate product information on its own. While either keywords or product codes are typically sent to product server 208, both keywords and product codes may be sent together.

Continuing with FIG. 4A, product server 208 receives the product request along with any keywords or product codes from user agent 102. When product codes are received, product server 208 pulls product information using the product code from database 212. If available inventory is indicated by database 212, then the product information corresponding to the product code is returned to the user agent 102.

When keywords are received by product server 208, a database 212 query is used to search for relevant products corresponding to the keywords. Product information is then returned to user agent 102.

Generally, the product information is formatted into standard markup language and sent back to the executed script, which requested the product information from product server 208. The product information sent from product server 208 to the user agent 102 can include, but is not limited to, a URL to an image of the product, a product description, a URL for more product information, and a URL for information on the vendor. Information regarding the vendor can include ratings, shipping rates, shipping address, etc. Importantly, and as described below, the product information includes a URL to immediately and directly purchase the product. As described above, SOAP or AJAX technologies may be used to perform the request.

Once the product information is received from product server 208 via network 210, browser 302 running on user agent 102 parses and renders the formatted markup language thereby displaying the product information to the user, preferably in the form of text 308 and images 306. Product information can also be displayed in the form of an advertisement. In FIG. 3, the URL for immediately purchasing the product is displayed on webpage 300 as a “Buy Now” hyperlink 310 or a hyperlink with anchor text that allows a user 204 of user agent 102 to buy the product immediately. Hyperlink 310 may link to a financial transaction shopping cart on the product server's 208 website freeing the host server 206 from having to possess any financial transaction infrastructure. The shopping cart page allows one to enter their name, credit card information, etc. to make a purchase.

With specific reference to the exemplary shopping cart feature as presented above, user agent 102 receives XML, HTML, or some other markup language from product server 208. In turn, the markup language is parsed and rendered on user agent 102. The markup language delivered by product server 208 includes information and a URL to form a link to product server 208, which can perform the financial transaction. From there, user 204 from user agent 102 can enter their name, credit card information, etc. to perform a financial transaction with product server 208.

Periodically, product information can be updated on webpage 300. In a preferred embodiment, product server 208 generates product information, formats it, and sends the information to user agent 102 after a period of time has elapsed. Alternatively, user agent 102 can request for additional product information after a period of time has elapsed. Because the scripts are dynamic, product information displayed on webpage 300 can be updated often to keep interest of user 204 on user agent 102.

While FIG. 4A describes product information coming from a single product server 208, multiple product servers 208 may be used for generating product information. In this regard, each product displayed on webpage 300 can come from a different product server 208. Furthermore, when product server 208 cannot satisfy the request for product information, the product request can be sent to another product server 208 on network 210. The forwarded request can include either the product codes, keywords, or both.

Preferably, host server 206 selects the product servers 208 used. In this embodiment, the host server 206 sends information about the product server 208 to be used through webpage 300. Alternatively, user agent 102 can select the product server 208 when executing the processes that request product information.

To generate revenue, product server 208 will pay host server 206 a fee each time product server 208 is accessed by user agent 102 through host server's 206 webpage 300. Otherwise, product servers 208 can pay a set fee for each day, month, or year host server 206 uses product server 208. Pay rates should also include “click-throughs”, thus encompassing ads viewed (CPM), clicked (CPC), and purchased. In other embodiments, host server 206 can generate revenue based on the products sold through the product information displayed on webpage 300 generated by host server 206.

When product information has been delivered to user agent 102, the database 212 typically suspends sale of the product while the user 204 has been sent the product information so that no other user agent 102 can request the same information. After a period of time has elapsed, generally, the suspended products will be released. On the other hand, when unlimited amount of products exist or the product can be easily produced, no hold on the product information is made.

In another embodiment, the URL for immediately purchasing the product can be provided in webpage 300 generated by host server 206 removing the need for any client script execution. Initially, and similar to the previous embodiment, user agent 102 sends a webpage 300 request to host server 206. Host server 206 receives the webpage 300 request and generates a webpage 300 in response to the request. A request is made to product server 208 from host server 206. Product server 208 receives the request for product information from host server 206. Product server 208 thereafter determines product information for a product for sale including a uniform resource locator (URL) to immediately and directly purchase the product for sale from product server 208. Product server 208 sends the product information about the product for sale to the host server 206 formatted into standard markup language. Host server 206 merges the product information formatted into standard markup language from product server 208 with page 300 based on the page 300 request and serves the page 300 to user agent 102.

To purchase a product from webpage 300, hyperlink 310 is selected by user 204 on browser 302 creating a purchase intent as shown in FIG. 4B. Hyperlink 310 corresponds to the URL for immediately purchasing the product delivered by the product server 208. Hyperlink 310 may link to a financial transaction shopping cart on the product server's 208 website freeing the host server 206 from having to possess any financial transaction infrastructure. The shopping cart page allows one to enter their name, credit card information, etc. to make a purchase.

The purchase intent is received by product server 208 through network 310, which allows for immediate purchase of the product. In turn, the product server 208 typically sends a confirmation of the purchase to user agent 102 and the purchase is completed. Through the routines described in FIGS. 4A and 4B, the number of processes to purchase a product is reduced. This not only increases the likelihood of a sale by a user 204, but the host server 206, who generated the webpage 300, does not have to provide financial infrastructure for the purchase.

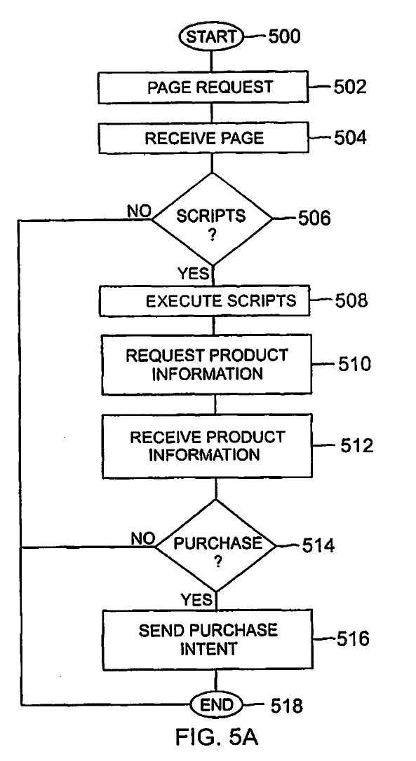

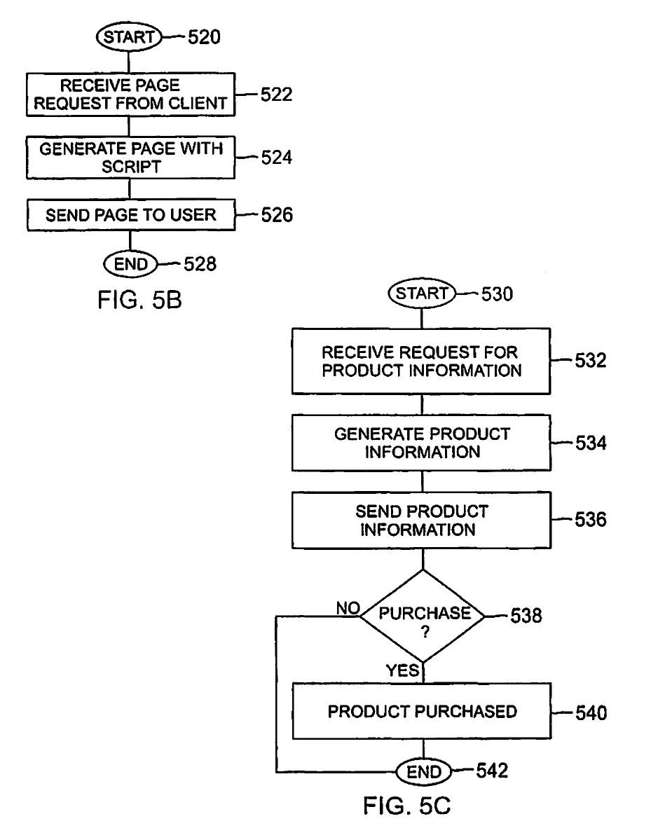

FIG. 5A is an exemplary flow chart showing illustrative processes used by user agent 102 to purchase a product through product server 208 using webpage 300 generated by host server 206 in accordance with one aspect of the present application. Initially, the user agent 102 begins at point 500. At block 502, user agent 102 generates a webpage 300 request to host server 206. Thereafter, user agent 102 receives a webpage 300 in response to the webpage 300 request from host server 206 at block 504.

At decision block 506, user agent 102 determines whether webpage 300 received from host server 206 includes any scripts. When no scripts are included, user agent 102 ends at point 518. If scripts were included within webpage 300, the scripts are executed at block 508. A set of keywords or product codes can be generated. When executed, the scripts request product information from product server 208 at block 510, possibly using the set of keywords or product codes. The product information may take the form of advertisements.

At block 512, product information is received from product server 208 along with a URL for immediately purchasing a product described by the product information. At decision block 514, the product described by the product information can be purchased immediately by selecting URL 310 for immediately purchasing the product from product server 208. If no product is chosen, user agent 102 ends at point 518. Otherwise, a purchase intent can be sent to product server 208. Typically, the user agent enters in financial information such as credit card information, PayPal account information, shipping and contact information, etc. from a page generated by product server 208 and not host server 206. This generally occurs after URL 310 has been selected by user 204. User agent 102 ends at point 516.

FIG. 5B is an exemplary flow chart showing illustrative processes used by host server 206 to generate webpage 300 so that products can be purchased through product server 208 in accordance with one aspect of the present application. Host server 206 begins at point 520. At block 522, host server 206 receives a webpage 300 request from user 204 through user agent 102 via network 210. Host server 206 generates webpage 300 at block 524. The webpage 300 incorporates markup language along with at least one script for execution by the user agent 102. When executed by user agent 102, a request to product server 208 is made for product information. Webpage 300 is sent to user agent 102 at block 526 ending the processes at point 528. Importantly, host server 206 does not provide any financial infrastructure for sending product information as well as for purchasing products corresponding to the product information. As described above and alternatively, webpage 300 generated by host server 206 can incorporate URL 310 for purchasing a product immediately from product server 208.

FIG. 5C is an exemplary flow chart showing illustrative processes used by product server 208 to generate product information so that the product information can be displayed on webpage 300 generated by host server 206 and products corresponding to the displayed product information capable of being directly purchased from product server 208 in accordance with one aspect of the present application. Product server 208 begins at point 530. At block 532, product server 208 receives a request for product information. Product information can be generated at block 534, possibly using keywords or product codes. At block 536, the product information is sent for immediate purchase to user agent 102 using a URL.

At decision block 538, product server 208 determines whether it has received a request to purchase the product indicated by the sent product information. If no purchase has been made, product server 208 ends at point 542. If a product has been purchased through the URL, the product server 208 allows the user 204 to purchase the product at block 540. Product server 208 ends at point 542.

Previously, the purchase of products using product information received from product server 208 was separate from webpage 300 generated by host server 206. In an alternative embodiment, host server 206 and product server 208 can be integrally related through a secured webpage 300 while host server 206 continues to provide no financial infrastructure for product information or purchasing of the product corresponding to the product information.

In accordance with one aspect of the present application, a system 200 for displaying products for sale on webpage 300 by web publisher 206 without the web publisher 206 providing any financial infrastructure for purchase of the products is presented. The products for sale on webpage 300 can be displayed through advertisements. The system includes a product server 208 connected to network 210. The product server 208 receives product requests from user agents 102 via network 210.

The product server 208 includes at least one processor 104, a database 212 for storing product information, and memory 106 operatively coupled to the processor 104. The memory 106 stores instructions that when executed by processor 104, causes the processor 104 to perform a plurality of processes. The processes include receiving a product request from user agent 102 via network 210 and determining product information about at least one product from database 212 based on the product request. Product information includes a uniform resource locator to immediately purchase the at least one product. The product information is sent to user agent 102 via network 210.

The program instructions executed by the processor 104 further cause the processor 104 to format the product information into standard markup language. Periodically, the program instructions executed by processor 104 further cause the processor to redetermine product information about at least one product from database 212 based on the product request after a period of time has elapsed. The product information is then resent to user agent 102 via network 210.

The program instructions executed by the processor 104 may further cause the processor 104 to receive a purchase intent from user agent 102 via network 210 for the at least one product corresponding to the product information. Thereafter, the processor 104 removes the at least one product from database 212 and sends the at least one product to user agent 102.

In accordance with another aspect of the present application, a computer readable medium storing instructions for causing at least one processor 104 to perform a method that allows user agent 102 to purchase products immediately via product server 208 using page 300 generated by host server 206 while freeing host server 206 from having to possess any financial transaction infrastructure is presented. The method includes generating a page 300 request to host server 206. User agent 102 receives a page 300 based on the page 300 request from host server 206.

In preferred embodiments, and in accordance with this aspect of the present application, page 300 includes embedded scripts. User agent 102 executes the scripts on page 300, wherein the scripts, when executed by processor 104, request product information from product server 208. The product information generally includes locators for immediate purchase of a product through the product server 208. User agent 102 receives the product information from product server 208. The information is displayed onto monitor 146 of user agent 102.

In the computer readable medium, the method for user agent 102 can further include selecting a product for purchase. The product is purchased directly through the locator provided by product server 208.

In accordance with yet another aspect of the present application, a computer-implemented method for providing a page 300 displaying at least one product for immediate purchase without providing infrastructure for such purchase is presented. The method, presented from the perspective of host server 206, includes receiving a page 300 request from a user agent 102. In addition, the method generates a page 300 based on the page 300 request, the page 300 including at least one script for execution by the user agent 102, wherein execution of the script by the user agent 102 causes the user agent 102 to request products from product server 208 for immediate purchase. The method includes sending the page 300 to user agent 102.

In accordance with another aspect of the present application, a system 200 is presented. System 200 includes a host server 206 receiving a page 300 request, wherein the host server 206 generates a page 300 in response to the page 300 request. The page 300 incorporates at least one script.

System 200 also includes user agent 102. User agent 102 receives page 300 from host server 206. When user agent 102 executes the at least one script within page 300, the script generates a request for product information.

Furthermore, system 200 includes at least one product server 208 for receiving the request for product information from the user agent 102. Product server 208 determines product information about at least one product including a uniform resource locator to directly purchase the at least one product from the product server 208. Product server 208 responds to the request for product information by sending the product information about the at least one product to user agent 102.

In accordance with yet another aspect of the present application, a method supported in a user computer system 102 having a display screen 146 and a graphical user interface (GUI) supporting a browser 302 is presented. The method allows for the purchase of a product directly from a third party website 208 using a webpage 300 generated by a host server 206 and displayed by the browser 302 supported on the GUI.

The method includes sending an HTTP request to the host server 206, wherein the host server 206 generates a webpage 300 in response to the HTTP request. Webpage 300 incorporates standard markup language code and JavaScript embedded within the standard markup language code.

Continuing, the method includes executing the JavaScript embedded within the standard markup language code. Execution of the JavaScript causes a request for product information from the third party website 208. The third party website 208 generates product information corresponding to the request for product information. The product information includes a URL for immediately purchasing a product. Typically, the product information is formulated into standard markup language.

The method receives the product information formulated into standard markup language from the third party website 208. The product information is returned to the JavaScript which caused the request for product information. The method displays the standard markup language code from the host server 206 and the product information formulated into standard markup language including the URL for immediately purchasing the product to the user through the browser 302 supported on the GUI.

In accordance with another aspect of the present application, an internet retail sales system 200 for reducing steps required to purchase an advertised product by a user agent 102 is presented. The system 200 includes a host server 206 for receiving a page 300 request, wherein the host server 206 generates a page 300 in response to the page 300 request. Normally, page 300 incorporates at least one script for displaying the advertised product.

In addition, the system includes a user agent 102 for receiving page 300 from host server 206. User agent 102 executes the at least one script within page 300, the script generating a request for product information about the advertised product.

System 200 also includes a product server 208 for receiving the request for product information about the advertised product from the user agent 102. Product server 208 determines product information about the advertised product including a uniform resource locator to directly purchase the advertised product from the product server 208. Product server 208 responds to the request for product information by sending the product information about the advertised product to the user agent 102.

User agent 102 receives from the user 204 a purchase intent for the advertised product. The purchase intent is sent to the product server 208, wherein the advertised product is purchased directly by the user 204 through the uniform resource locator.

In accordance with another aspect of the present application, a computer-implemented method for providing a page 300 displaying at least one product for immediate purchase without providing infrastructure for such purchase is presented. The method includes receiving a page 300 request from a user agent 102 and generating a page 300 based on the page 300 request. In addition, the method includes requesting product information from a third party website, the third party website generating the product information corresponding to the product information request, the product information including a URL for immediately purchasing a product and formatted into standard markup language. Furthermore, the method includes receiving the product information formatted into standard markup language from the third party website. The method also includes merging the product information formatted into standard markup language from the third party website with the page 300 based on the page 300 request and serving the page 300 to the user agent.

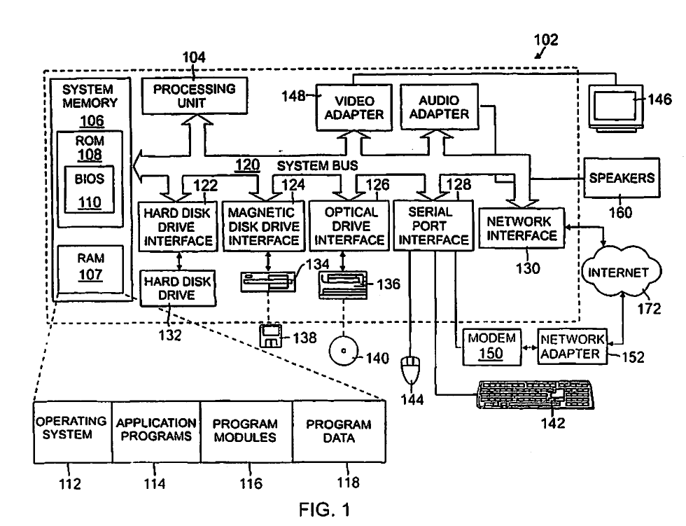

An exemplary hardware and operating environment for implementing an internet retail sales system may include a general purpose user agent 102 as shown in FIG. 1. The user agent 102 may be in the form of a computer 102, including a processing unit 104, a system memory 106, and a system bus 120 that operatively couples various system components, including the system memory 106 to the processing unit 104. There may be only one or there may be more than one processing unit 104, such that the processor of computer 102 comprises a single central processing unit (CPU), or a plurality of processing units, commonly referred to as a parallel processing environment The computer 102 may be a conventional computer, a distributed computer, a web server, a file server, or any other type of computer.

The system bus 120 may be any of several types of bus structures including a memory bus or memory controller, a peripheral bus, a switched fabric, point-to-point connections, and a local bus using any of a variety of bus architectures. The system memory 106 may also be referred to as simply the memory, and includes read only memory (ROM) 108 and random access memory (RAM) 107. A basic input/output system (BIOS) 110, containing the basic routines that help to transfer information between elements within the computer 102, such as during start-up, is stored in ROM 108. The computer 102 further includes a hard disk drive 132 for reading from and writing to a hard disk, not shown, a magnetic disk drive 134 for reading from or writing to a removable magnetic disk 138, and an optical disk drive 136 for reading from or writing to a removable optical disk 140 such as a CD ROM or other optical media.

The hard disk drive 132, magnetic disk drive 134, and optical disk drive 136 are connected to the system bus 120 by a hard disk drive interface 122, a magnetic disk drive interface 124, and an optical disk drive interface 126, respectively. The drives and their associated computer-readable media provide nonvolatile storage of computer-readable instructions; data structures, e.g., a catalog and a context-based index; program modules, e.g., a web service and an indexing robot; and other data for the computer 102. It should be appreciated by those skilled in the art that any type of computer-readable media that can store data that is accessible by a computer, for example, magnetic cassettes, flash memory cards, digital video disks, RAM, and ROM, may be used in the exemplary operating environment.

A number of program modules may be stored on the hard disk 132, magnetic disk 134, optical disk 136, ROM 108, or RAM 107, including an operating system 112, one or more application programs 114, other program modules 116, and program data 118. A user may enter commands and information into the personal computer 102 through input devices such as a keyboard 142 and pointing device 144, for example, a mouse. Other input devices (not shown) may include, for example, a microphone, a joystick, a game pad, a tablet, a touch screen device, a satellite dish, a scanner, a facsimile machine, and a video camera. These and other input devices are often connected to the processing unit 104 through a serial port interface 128 that is coupled to the system bus 120, but may be connected by other interfaces, such as a parallel port, game port or a universal serial bus (USB).

A monitor 146 or other type of display device is also connected to the system bus 120 via an interface, such as a video adapter 148. In addition to the monitor 146, computers typically include other peripheral output devices, such as a printer and speakers 160. These and other output devices are often connected to the processing unit 104 through the serial port interface 128 that is coupled to the system bus 120, but may be connected by other interfaces, such as a parallel port, game port, or a universal serial bus (USB).

The computer 102 may operate in a networked environment using logical connections to one or more remote computers. These logical connections may be achieved by a communication device coupled to or integral with the computer 102; the application is not limited to a particular type of communications device. The remote computer may be another computer, a server, a router, a network personal computer, a client, a peer device, or other common network node, and typically includes many or all of the elements described above relative to the computer 102, although only a memory storage device has been illustrated in FIG. 1. Computer 102 can be logically connected to the internet 172. The logical connection can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer 102 may be connected to the local network through a network interface or adapter 130, which is one type of communications device. When used in a WAN environment, the computer 102 typically includes a modem 150, a network adapter 152, or any other type of communications device for establishing communications over the wide area network. The modem 150, which may be internal or external, is connected to the system bus 120 via the serial port interface 128. In a networked environment, program modules depicted relative to the personal computer 102, or portions thereof, may be stored in a remote memory storage device. It is appreciated that the network connections shown are exemplary and other means of and communications devices for establishing a communications link between the computers may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The embodiments presented herein of the internet retail sales system and method are preferably computer programs run on a computer system. One skilled in the relevant art will appreciate that the computer system can include code that is loaded from a hard drive to be run on the processor. Alternatively, the system can be saved on a suitable storage medium such as a diskette, a CD, or like devices.

The system can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. The internet 210 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers and other related electronic devices can be remotely connected to either the LANs or the WAN via a digital communications device, modern and temporary telephone, or a wireless link. It will be appreciated that the internet comprises a vast number of such interconnected networks, computers, and routers.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HTML, or other markup languages, that are electronically stored at or dynamically generated by “WWW sites” or “Web sites” throughout the Internet. Additionally, client-side software programs that communicate over the Web using the TCP/IP protocol are part of the WWW, such as web browsers, SOAP clients, JavaScript, Java Applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments, however, for purposes of discussion, the Web is used as an exemplary interactive hypertext environment with regard to the present application.

A website is a server/computer connected to the Internet that has storage capabilities for storing hypertext documents and that runs administrative software for handling requests for those stored hypertext documents as well as dynamically generating hypertext documents. Embedded within a hypertext document are a number of hyperlinks, i.e., highlighted portions of text which link the document to another hypertext document possibly stored at a website elsewhere on the Internet. Each hyperlink is assigned a URL that provides the name of the linked document on a server connected to the Internet. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Mozilla Firefox or Microsoft's Internet Explorer, is a software application program for providing a user interface to the WWW. Upon request from the remote access user via the web browser, the web browser requests the desired hypertext document from the appropriate web server using the URL for the document and the hypertext transport protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JavaScript or JAVA applets, for execution on the client computer. Finally, the WWW browser may include optional software components, called plug-ins, that run specialized functionality within the browser.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the art are expressly incorporated herein by reference and intended to be encompassed by the claims. Moreover, nothing disclosed herein is intended to be dedicated to the public regardless of whether such disclosure is explicitly recited in the claims.

What is claimed is:

1. In a user computer system having a display screen and a graphical user interface (GUI) supporting a browser, a method for purchasing products directly from a third party website using a webpage generated by a host server and displayed by the browser supported on the GUI, the method comprising:
sending an HTTP request to the host server, wherein the host server generates a webpage in response to the HTTP request, the webpage incorporating standard markup language and JavaScript embedded within the standard markup language;
executing the JavaScript embedded within the standard markup language, wherein execution of the JavaScript causes a request for product information from the third party website, the third party website generating product information corresponding to the request for product information, the product information including a URL for immediately purchasing a product, the product information formulated into standard markup language;
receiving the product information formulated into standard markup language from the third party website, the product information returned to the JavaScript which caused the request for product information; and
displaying the standard markup language from the host server and the product information formulated into standard markup language including the URL for immediately purchasing the product to the user through the browser supported on the GUI.

2. In the user computer system of claim 1, wherein the JavaScript exchanges information with a third party product server using Simple Object Access Protocol (SOAP).

3. In the user computer system of claim 1, wherein the JavaScript exchanges information with a third party product server using asynchronous JavaScript and XML (AJAX).

4. In the user computer system of claim 1, the product information further comprising a product description, an optional product image, an optional URL for additional information about the product, and an optional URL for information regarding a vendor of the product.

5. In the user computer system of claim 1, wherein the method further comprises providing a purchase intent through the URL for immediately purchasing the product to the third party website.

6. In the user computer system of claim 5, wherein providing the purchase intent uses a “Buy Now” link on the GUI.

7. In the user computer system of claim 5, wherein execution of the JavaScript causing a request for product information from the third party website incorporates keywords.

8. In the user computer system of claim 7, wherein the keywords are generated by the user computer system.

9. In the user computer system of claim 7, wherein the keywords are generated by the host server and passed to the user computer system.

10. A system comprising:
a host server receiving a page request, wherein the host server generates a page in response to the page request, the page incorporating at least one script;
a client computer receiving the page from the host server, wherein the client computer executes the at least one script within the page, the script generating a request for product information; and
at least one product server for receiving the request for product information from the client computer, wherein the product server determines product information about at least one product including a uniform resource locator to directly purchase the at least one product from the product server, the product server responding to the request for product information by sending the product information about the at least one product to the client computer.

11. The system of claim 10, wherein the page generated by the host server includes hypertext markup language along with the at least one script.

12. The system of claim 10, wherein the client computer selects a product server from a plurality of product servers.

13. The system of claim 10, wherein the host server selects a product server from a plurality of product servers, the page incorporating the selection.

14. The system of claim 13, wherein the client computer receiving the page from the host server, the page incorporating the product server selection, comprises requesting product information from the selected product server.

15. The system of claim 10, wherein the host server, client computer, and product server are connected through a network.

16. A system comprising:
a server connected to a network, the server receiving product requests from user agents via the network, the server comprising:
at least one processor;
a database for storing product information; and
a memory operatively coupled to the processor, the memory storing program instructions that when executed by the processor, causes the processor to:
receive a product request from a user agent via the network;
determine product information about at least one product from the database based on the product request, the product information including a uniform resource locator to immediately purchase the at least one product;
send the product information to the user agent via the network.

17. The system of claim 16, wherein product information further comprises product codes, keyword tags, uniform resource locators for product images, product descriptions, and uniform resource locators for vendor information.

18. The system of claim 16, wherein the program instructions executed by the processor further cause the processor to verify the user agent.

19. The system of claim 16, wherein the product request from the user agent includes keywords, the program instructions when executed by the processor causes the processor to determine the product information about the at least one product from the database by matching the keywords with keyword tags of the at least one product.

20. The system of claim 16, wherein the product request from the user agent includes keywords, the program instructions when executed by the processor causes the processor to determine the product information about the at least one product from the database by matching keywords with product codes of the at least one product.

21. The system of claim 16, wherein the program instructions executed by the processor further cause the processor to format the product information into hypertext markup language.

22. The system of claim 16, wherein the program instructions executed by the processor further cause the processor to:
redetermine product information about at least one product from the database based on the product request after a period of time has elapsed; and
resend the product information to the user via the network.

23. The system of claim 16, wherein the program instructions executed by the processor further cause the processor to retrieve product information from suppliers.

24. The system of claim 16, wherein the program instructions executed by the processor further cause the processor to suspend sale of the at least one product while the user agent has been sent the product information.

25. The system of claim 24, wherein the program instructions executed by the processor further cause the processor to release the suspension of the at least one product after a period of time has elapsed.

26. The system of claim 16, wherein the program instructions executed by the processor further cause the processor to:
receive a purchase intent from the user agent via the network for the at least one product;
remove the at least one product from the database; and
transact a purchase based on the purchase intent.

27. The system of claim 16, wherein the program instructions executed by the processor cause the processor to send the product request to another server via the network.

28. A computer readable medium storing instructions for causing at least one processor to perform a method that allows a user to purchase products immediately from a product server using pages generated by a host server while freeing the host server from having to possess any financial transaction infrastructure, the method comprising:
generating a page request to the host server;
receiving a page based on the page request from the host server, the page having scripts embedded therein;
executing the scripts on the page, wherein the scripts, when executed by the processor, request product information from the product server, the product information including locators for immediate purchase of a product through the product server;
receiving product information from the product server; and
displaying the product information from the product server.

29. The computer readable medium of claim 28, wherein the method further comprises generating keywords to request product information from the product server.

30. The computer readable medium of claim 29, wherein keywords are produced by the host server.

31. The computer readable medium of claim 28, wherein displaying the product information comprises displaying an image and description of the product.

32. The computer readable medium of claim 31 wherein displaying the product information is in a separate page.

33. The computer readable medium of claim 31, wherein displaying the product information is a banner or ad.

34. The computer readable medium of claim 28, wherein the method further comprises:
selecting a product for purchase;
purchasing the product directly through the locator provided by the product information through the product server.

35. The computer readable medium of claim 28, wherein the method further comprises selecting the product server.

36. A computer-implemented method for providing a page displaying at least one product for immediate purchase without providing infrastructure for such purchase, the method comprising:
receiving a page request from a user agent;
generating a page based on the page request, the page including at least one script for execution by the user agent, wherein execution of the script by the user agent causes the user agent to request products from a product server for immediate purchase; and
sending the page to the user agent.

37. The computer-implemented method of claim 36, wherein the method further comprises providing keywords for the script to generate products.

38. The computer-implemented method of claim 36, wherein the method further comprises providing the location of the product server for the script to generate products.

39. The computer-implemented method of claim 36, wherein the method further comprises receiving a purchase intent from the user agent and passing the purchase intent to the product server.

40. An internet retail sales system for reducing steps required to purchase an advertised product by a user, the system comprising:
a host server for receiving a page request, wherein the host server generates a page in response to the page request, the page incorporating at least one script for displaying the advertised product;
a client computer receiving the page from the host server, wherein the client computer executes the at least one script within the page, the script generating a request for product information about the advertised product;
a product server for receiving the request for product information about the advertised product from the client computer, wherein the product server determines product information about the advertised product including a uniform resource locator to directly purchase the advertised product from the product server, the product server responding to the request for product information by sending the product information about the advertised product to the client computer; and
the client computer receiving from the user a purchase intent for the advertised product and sending the purchase intent to the product server, wherein the advertised product is purchased directly by the user through the uniform resource locator.

41. The internet retail sales system of claim 40, wherein the advertised product is displayed on the client computer through a banner advertisement.

42. A computer-implemented method for providing a page displaying at least one product for immediate purchase without providing infrastructure for such purchase, the method comprising:
receiving a page request from a user agent;
generating a page based on the page request;
requesting product information from a third party website, the third party website generating the product information corresponding to the product information request, the product information including a URL for immediately purchasing a product and formatted into standard markup language;
receiving the product information formatted into standard markup language from the third party website;
merging the product information formatted into standard markup language from the third party website with the page based on the page request; and
serving the page to the user agent.
